(19) United States
(12) Patent Application Publication
(10) Pub. No.: US 2012/0319492 A1
(43) Pub. Date: Dec. 20, 2012

(54) POWER CONTROL METHOD AND ELECTRONIC DEVICE

(75) Inventor: Keiji Saito, Ome-shi (JP)

(73) Assignee: KABUSHIKI KAISHA TOSHIBA, Tokyo (JP)

(21) Appl. No.: 13/432,953

(22) Filed: Mar. 28, 2012

(30) Foreign Application Priority Data
Jun. 14, 2011 (JP) 2011-132309

(51) Int. Cl. H02J 4/00

(52) U.S. Cl. 307/80

(57) ABSTRACT

According to one embodiment, a power control method includes receiving supply amount information regarding a limit of supply amount of commercial power and consumption information regarding consumption of the commercial power in the past time, generating predictive information regarding a predictive value of consumption of commercial power at a time after the past time based on the received consumption information, and driving an electronic device by switching between a commercial power supply and a battery power supply according to the received supply amount information and the generated predictive information.

### CROSS REFERENCE TO RELATED APPLICATION(S)

This application is based upon and claims the benefit of priority from Japanese Patent Application No. 2011-132309 filed on Jun. 14, 2011, the entire contents of which are incorporated herein by reference.

### FIELD

Embodiments described herein relate generally to a power control method and an electronic device.

When power consumption (power demand) of commercial power supplied by an electric power company is increased, there is a technology of suppressing consumption of commercial power by controlling the operation of an electronic device consuming the power.

When the commercial power consumed by the electronic device is to be suppressed, the suppression may be performed at an appropriate time in consideration of the power consumption in an area in which power is supplied by the electric power company.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary diagram showing a configuration example of a power control system according to an embodiment;

FIG. 2 is an exemplary diagram showing a system configuration example of a distribution server, a processing server, a portable terminal and a display device according to the embodiment;

FIG. 3A is an exemplary diagram showing a data configuration example of power information published by the distribution server;

FIG. 3B is an exemplary diagram showing a data configuration example of power information in a format different from FIG. 3A, which is distributed by the distribution server;

FIG. 3C is an exemplary diagram showing the data configuration example of power information generated by the processing server, the portable terminal and the display device based on the power information acquired from the distribution server;

FIG. 4 is an exemplary diagram showing an example of power supply switching and operation mode switching by the display device;

FIG. 5 is an exemplary diagram showing an example of a notification screen that is displayed by the display device;

FIG. 6 is an exemplary flow chart showing an example of a processing flow by the processing server and the display device according to the embodiment;

FIG. 7 is an exemplary flow chart showing an example of a processing flow by the display device according to the embodiment; and

FIG. 8 is an exemplary flow chart showing an example of a processing flow by the portable terminal and the display device according to the embodiment.

### DETAILED DESCRIPTION

In general, according to one embodiment, a power control method includes receiving supply amount information regarding a limit of supply amount of commercial power and consumption information regarding consumption of the commercial power in the past time, generating predictive information regarding a predictive value of consumption of commercial power at a time after the past time based on the received consumption information, and driving an electronic device by switching between a commercial power supply and a battery power supply according to the received supply amount information and the generated predictive information.

Hereinafter, exemplary embodiments will be described with reference to the accompanying drawings.

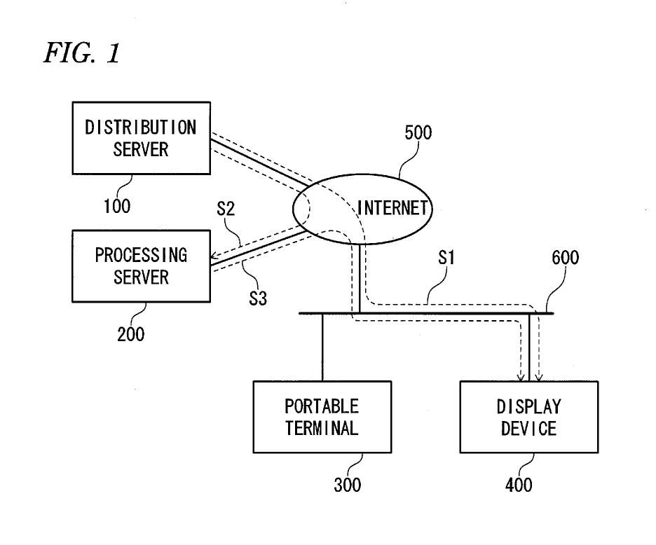

FIG. 1 is a diagram showing a configuration example of a power control system according to an embodiment. The power control system includes, for example, a distribution server 100, a processing server 200, a portable terminal 300, a display device 400, an Internet 500 and a home network 600. In this configuration, the distribution server 100, the processing server 200 and the home network 600 are connected to the Internet 500. Further, the portable terminal 300 and the display device 400 are connected to the home network 600.

The distribution server 100 publishes the power information regarding the commercial power supplied by an electric power company in a certain format on the Internet 500. In this case, the power information includes, for example, power supply amount information regarding the maximum value (limited value) of power that can be supplied by the electric power company, a record of power usage (consumption) of the day within an area under the control of the electric power company, a record of power usage (consumption) of the previous day within the area under the control and a record of power usage (consumption) of the same date of last year within the area under the control. That is, the power information includes power supply potential and power usage in the past. The records of power usage of the day, the previous day, the same day of last year become values measured, for example, per one hour. The record of power usage of the day is updated and published, for example, per one hour. Further, the distribution server 100 transmits the power information to the processing server 200 or the display device 400 according to requests from these devices (S1 and S2). In addition, the distribution server 100 may transmit the power information to the portable terminal 300 according to the request from the portable terminal 300.

The processing server 200 acquires the power information published by the distribution server 100 (S2) and calculates a predictive value of power usage at current time depending on the power information. Further, the processing server 200 generates the power information of a certain format corresponding to the display device 400, including the calculated predictive value, and transmits the power information to the display device 400 (S3).

The display device 400 acquires the power information from the distribution server 100 and/or the processing server 200. Further, when the display device 400 acquires the power information from the distribution server 100 (S1), the display device 400 calculates the predictive value of power usage at the current time using the power information, similar to the processing server 200. In addition, when the display device 400 cannot acquire the power information from the distribution server 100, the display device 400 may acquire the power information from the processing server 200, or may primarily acquire the power information from the processing server 200 as initial setting (S3).

The display device 400 performs, for example, a power switching control and an operation mode control of its own device, based on the acquired power information. That is, the display device 400 performs the power switching control and the operation mode control depending on the power supply amount and the power consumption at the current time based on the acquired power information. In this configuration, the display device 400 controls the power switching and the operation mode according to the ratio of the power consumption to the power supply amount. That is, when the predictive value of current power consumption calculated by the processing server 200 or the display device 400 exceeds a certain ratio for the power supply amount, the display device 400 controls switching of the driving power of its own device from the commercial power supply into the battery power supply, or controls suppressing luminance of a display module of its own device.

In the system of FIG. 1, the portable terminal 300 may also acquire the power information from the distribution server 100 or the processing server 200 (a data path of the power information to the portable terminal 300 is not shown). In this case, when the portable terminal 300 acquires the power information from the distribution server 100, the portable terminal 300 calculates the predictive value of power usage at the current time based on the power information. Further, the portable terminal 300 generates a control command according to the predictive value of current power consumption calculated by the processing server 200 or the portable terminal 300 and according to the power supply amount included in the acquired power information. In this case, the control command includes a command that indicate switching of the power supply and an operation mode for the display device 400. That is, when the predictive value of current power consumption calculated by the processing server 200 or the portable terminal 300 exceeds the certain ratio for the power supply amount, the portable terminal 300 generates a command that instructs a control of switching the driving power of the display device 400 from the commercial power to the battery power or a control of suppressing the luminance of the display module of its own device, and transmits the command to the display device 400.

In the above-mentioned embodiment, there may be a case where the processing server 200, the portable terminal 300 and the display device 400 cannot acquire the power information from the distribution server 100. It is because that, for example, the update of the power information at the distribution server 100 stops for any reason or a communication path from the distribution server 100 to the processing server 200, the portable terminal 300 and the display device 400 is interrupted by a power outage. When the format of the power information published by the distribution server 100 is changed, there may be a case in which the display device 400 or the portable terminal 300 cannot process the power information of the format. Even in this case, in the embodiment, the processing server 200 may calculate the predictive value of current power usage based on data acquired in the past from the distribution server 100 and transmit the power information including the predictive value to the portable terminal 300 or the display device 400 by the format corresponding to these devices.

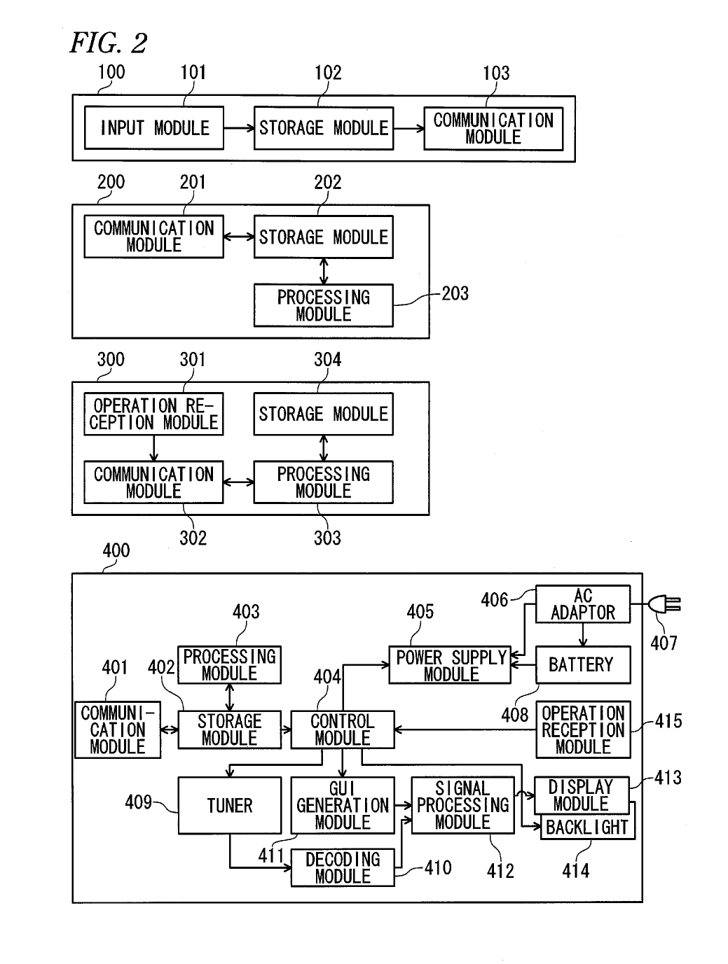

The system configuration example of the distribution server 100, the processing server 200, the portable terminal 300 and the display device 400 will be described below with reference to FIG. 2.

The distribution server 100 includes, for example, an input module 101, a storage module 102 and a communication module 103. In this configuration, the power information is input to the input module 101. That is, the input module 101 is input, for example, with the power supply amount information regarding the maximum value of power that can be supplied by the electric power company, the record of power usage of the previous day, and a record of power usage of the same date last year. The information is input, for example, every day. Further, the record of power usage of the previous day and the same date of last year is constituted of a value, for example, per one hour. In addition, the record of power usage of the day per one hour may be input to the input module 101 on an hourly basis.

The storage module 102 stores the power information that is input to the input module 101. Further, when new information is input to the input module 101, the storage module 102 stores the power information in the format reflecting the input information. The communication module 103 receives the request for the power information from the processing server 200, the portable terminal 300 and the display device 400 and transmits the power information stored in the storage module 102 to the device that transmitted the request.

The system configuration example of the processing server 200 will be described below. The processing server 200 includes various processing modules such as a communication module 201, a storage module 202 and a processing module 203. The communication module 201 acquires the power information published by the distribution server 100. Further, the communication module 201 acquires the power information per certain time, for example, 10 minutes. However, when updating and publishing time for the power information of the distribution server 100 is not determined, the communication module 201 may perform the acquiring process per a period as short as possible, for example, several seconds. In addition, the communication module 201 may acquire the information that may be used to predict the power usage in an area in which the electric power company supplies power, from another server on the Internet. Herein, an example of information that may be used to predict the power usage may include the weather of the past, weather forecast information of the day (temperature, amount of sunshine, amount of rainfall and humidity).

The storage module 202 stores information such as power information acquired by the communication module 201. The processing module 203 calculates the predictive value of power usage of current or future based on the information stored in the storage module 202. Further, the processing module 203 generates the power information including the calculated predictive value and stores the power information in the storage module 202. In addition, the processing module 203 may also generate a plurality of power information each of which has different formats.

When communication module 201 receives the request of the power information from the portable terminal 300 or the display device 400, the communication module 201 transmits a response that includes the power information having the generated predictive value. Further, the communication module 201 may receive a request for power information including device identifiers of the portable terminal 300 or the display device 400, or including the information of the format of the power information corresponding to the portable terminal 300 or the display device 400. In this case, the communication module 201 may also transmit the power information for the format according to the device identifier or the format information included in the power information request among the plurality of power information stored in the storage module 202.

That is, the processing server 200 corresponds the device identifier with the format that corresponds to the device indicated by the device identifier, and stores them in the storage module 202. Thereafter, when the device identifier is included in the power information request, the power information is transmitted with the format that corresponds to the device identifier. Further, the processing server 200 acquires the information regarding the device identifier and the format corresponding to the device indicated by the device identifier with various methods. The server device may receive the format information from, for example, a server device on the network. Alternatively, the format information may be input to the server device 200 by, for example, the user operation.

Meanwhile, when the information regarding the format is included in the power information request, the server device 200 temporarily stores the information in a memory (e.g., the storage module 202) and transmits the power information according to the stored format information. The server device 200 transmits the power information based on the format information acquired and stored by the own device.

Next, the system configuration example of the portable terminal 300 will be described. The portable terminal 300 includes various operation modules such as an operation reception module 301, a communication module 302, a storage module 303 and a processing module 304.

The operation reception module 301 is, for example, a button mounted in, for example, housing, a touch panel or a touch pad, and receives operation inputs from a user. In this case, the operation reception module 301 receives, for example, operations instructing to acquire the power information. Further, upon receiving the command to acquire the power information, the operation reception module 301 instructs the communication module 302 to acquire the power information.

The communication module 302 acquires the power information according to the instruction from the operation reception module 301. Further, the communication module 302 requests the power information to the distribution server 100 and/or the processing server 200 to acquire the power information. In addition, when acquiring the power information, the communication module 302 may transmit the power information request including the device identifier of the portable terminal 300 or the information of the format corresponding to the portable terminal 300.

The storage module 303 stores power information acquired by the communication module 302. In this case, the processing module 304 calculates the predictive value of power usage of current or future based on the power information when the communication module 302 acquires the power information from the distribution server 100. Further, the processing module 304 generates the power information including the calculated predictive value and stores the power information in the storage module 303. In this case, the processing module 304 acquires the information in advance for the format of power information corresponding to, for example, the display device 400, and generates the power information of the format. In addition, the processing module 304 generates the power information with the format for the display device 400 from the power information acquired from the processing server 200, and stores the generated power information in the storage module 303 even though the power information acquired from the processing server 200 is the format that does not correspond to the display device 400.

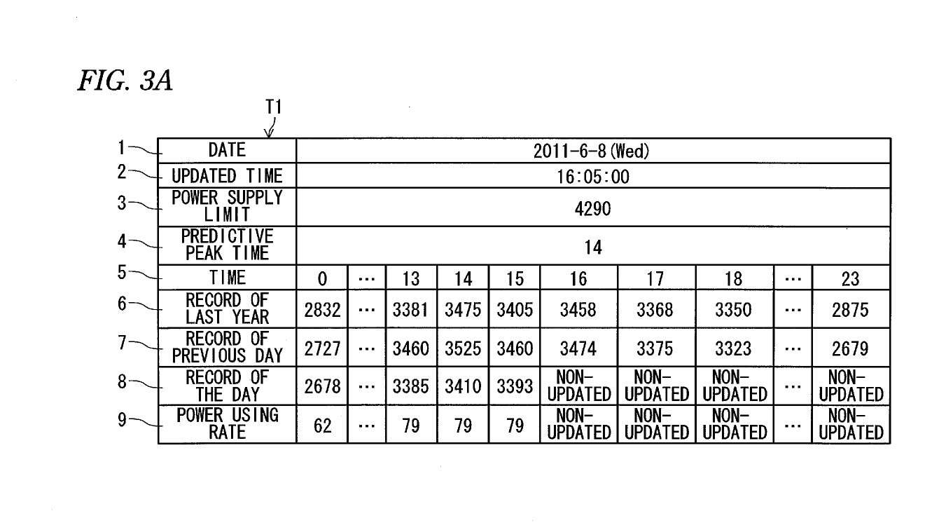

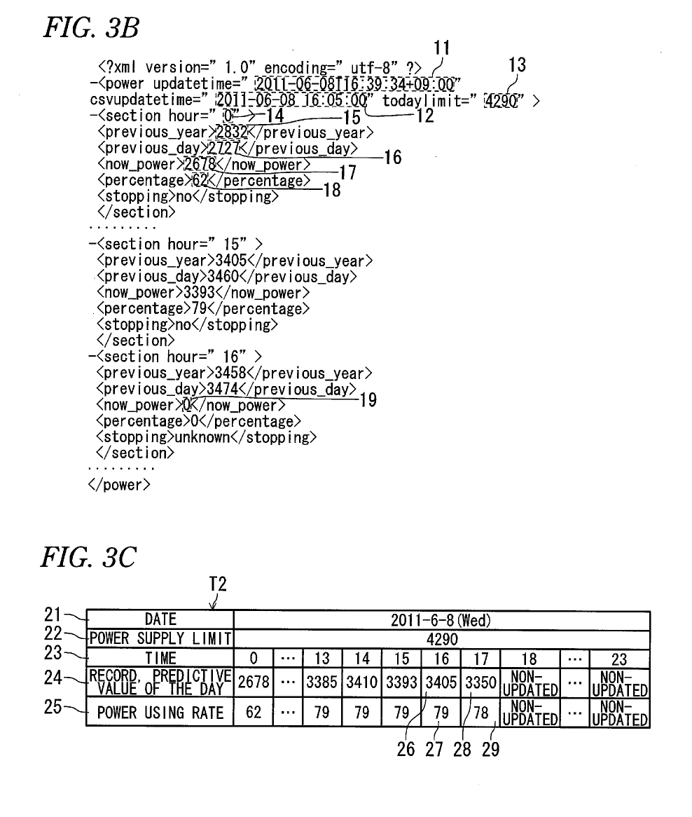

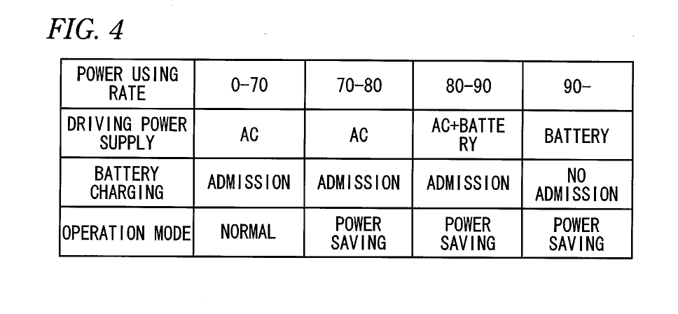

The processing module 304 may generate the control command of the display device 400 based on the calculated predictive value and the acquired power supply information, and store the control command in the storage module 303. The control command will be described below with reference to FIGS. 3 and 4.

The communication module 302 transmits the power information or the control command stored in the storage module 303 to the display device 400. That is, when the portable terminal 300 receives the operation input from the user, the portable terminal 300 acquires the power information, generates new power information from the power information as needed, and transmits the acquired power information or the generated power information or the control command to the display device 400.

Next, the system configuration example of the display device 400 will be described below. The display device 400 includes, for example, a communication module 401, a storage module 402, a processing module 403, a control module 404, a power supply module 405, an AC adaptor 406, a plug 407, a battery 408, a tuner 409, a decoding module 410, a GUI generation module 411, a signal processing module 412, a display module 413, a backlight 414 and an operation reception module 415.

The communication module 401 transmits the power information request to the distribution server 100 or the processing server 200, and acquires the transmitted power information for the request. The communication module 401 may transmit the power information request per a certain period. When the communication module 401 acquires the power information, the communication module 401 may transmit the power information request including the device identifier of the display device 400 or the information for the format corresponding to the portable terminal 300. The communication module 401 has a function of receiving the control command transmitted from the portable terminal 300, and outputs the received power information or the control command to the storage module 402.

The storage module 402 stores the power information or the control command received from the communication module 401. In this case, the processing module 403 calculates the predictive value of power usage of current or future based on the power information when the communication module 401 acquired the power information from the distribution server 100. Further, the processing module 403 generates the power information including the calculated predictive value and stores the power information in the storage module 402.

The control module 404 controls the switching of the driving power and the operation mode of the display device 400 based on the power information or the command stored in the storage module 402. The control module 404 instructs the power supply module 405 to switch the driving power supply when controlling the driving power supply. Further, when the operation mode is controlled, the control module 404 instructs the backlight 414 to operate in a power saving mode, e.g., to suppress the lighting of the backlight 414. Further, the control module 404 instructs the GUI generation module 411 to generate a notification screen according to the power information or the command stored in the storage module 402.

The power supply module 405 has a function of supplying power input from the AC adaptor 406 or the battery 408 to each component of the display device 400. In this case, the power supply module 405 uses, as the driving power, power from a module either of the AC adaptor 406 or the battery 408 according to the instruction from the control module 404.

The AC adaptor 408 is connected with the plug 407 through a power cord and inputs power from the commercial power supply. Further, the battery 408 has a function of charging power input to the AC adaptor 406 and a function of outputting the charged power to the power supply module 405. In addition, the battery 408 may be accommodated in the housing of the display device 400 or may be an external battery connected to the display device 400.

The tuner 409 receives a broadcast wave of terrestrial digital or BS digital. Further, the tuner 409 may include, for example, a module that receives a broadcast wave of full segment and a module that receives a broadcast wave of one segment. In addition, when the control module 404 instructs the tuner 409 to be operated in the power saving mode, the tuner 409 may stop an operation of a receiving module for the full segment to receive the broadcast wave by the receiving module for the one segment. The decoding module 410 decodes video data included in the broadcast wave received by the tuner 409 and outputs the decoded video data to the signal processing module 412.

The GUI generation module 411 generates the notification screen according to the instruction from the control module 404 and outputs the video data on the screen to the signal processing module 412.

The signal processing module 412 converts the video data input from the decoding module 410 or the GUI generation module 411 into the video signal that may be displayed by the display module 413, and outputs the converted video signal to the display module 413. The display module 413 displays the video using the input video signal and the backlight 414 lights the display module 413. The backlight 414 has a function of changing illuminance of lighting according to the command of the control module 404.

The operation reception module 415 receives the operation input from the user. In this case, the operation reception module 415 receives, for example, an operation of instructing the switching of driving power of the display device 400 and an operation of commanding the switching of the operation mode, an operation of instructing the control of other electronic devices connected to the network. Further, the operation reception module 415 output the operation input to the control module 404.

A configuration example of the power information will be described below with reference to FIG. 3.

FIG. 3A is a diagram showing a configuration example of data of the power information published by the distribution server 100. The distribution server 100 publishes the power information, for example, as power information table T1 in a CSV format. In this case, in the table T1, a row 1 stores a target date (year-month-day) for the data of the table T1, a row 2 stores update time of the table T1, a row 3 stores a limited amount of power supply from the electric power company, and a row 4 stores peak time of the predicted power usage.

Time at the date indicated in the row 1 is stored in the row 5 per one hour and data corresponding to each time indicated in the row 5 is stored in rows under the row 5. The record of power usage at the same date last year is stored in the row 6 and the record of power usage of the previous day is stored in the row 7, and the record of power usage of the day is stored in the row 8. Further, the record of power using rate of the day is stored in the row 9.

Since the data input to the distribution server 100 among the records of the day are stored in the row 8, data indicating, for example, non-update is stored in at a portion in which the data of the record are not updated. Similarly, in the row 9, the data indicating, for example, the non-update are stored in a portion in which the record is not stored. Further, the data of the record of the day may be updated, for example, in real time. In some cases, the data of the record of the day may not be updated for several hours or several days.

FIG. 3B is a diagram showing a data configuration example of power information in a format different from FIG. 3A, which is distributed by the distribution server 100. The distribution server 100 distributes, for example, the power information in an XML format. In this case, a target date for the data of power information is stored at the range 11, the update time of power information is stored at the range 12, a limited amount of power supply from the electric power company is stored at the range 13, and the target time for data in the ranges 15 to 18 is stored at the range 14, as described below.

The range 15 stores the record of power using rate at the same date of last year, the range 16 stores the record of power usage of the previous day, the range 17 stores the record of power usage of the day, the range 18 stores the record of power using rate of the day. Further, since the record of power usage of the day is stored as the data for time input to the distribution server 100, zero is stored in the portion in which the data of the record are not updated as in the range 19.

FIG. 3C is a diagram showing the data configuration example of power information generated by the processing server 200, the portable terminal 300 and the display device 400 based on the power information acquired from the distribution server 100. Further, a power information data table T2 is generated based on the power information of FIG. 3A or 3B. That is, the table T2 is generated based on the power information in which the records of power usage and power using rate of the day after 16 o'clock are not stored.

In the table T2, for example, a row 21 stores target date (year-month-day) for the data of the table T2 and a row 22 stores the limited amount of power supply from the electric power company. Further, time at the date indicated in the row 21 is stored in a row 23 per, for example, one hour and data corresponding to each time indicated in the row 23 are stored in rows 24, 25 below the row 23.

A row 24 stores the record of power usage of the day and the predictive value of power usage. That is, the power information of FIG. 3A or 3B does not include the record of power usage at a time after 16 o'clock but the processing server 200, the portable terminal 300 and the display device 400 calculate the predictive value of power usage after 16 o'clock based on the record of power usage at a time before 16 o'clock.

In this case, the processing server 200, the portable terminal 300 and the display device 400 calculate the predictive value of power usage after 16 o'clock by using, for example, the record of the past time that approaches 16 o'clock. The processing server 200 expands a curve of a trend of the record at, for example, 0 o'clock to 15 o'clock of the same day until after 16 o'clock by performing, for example, linear prediction or prediction by approximation curve to calculate the predictive value of power usage after 16 o'clock.

The processing server 200, the portable terminal 300 and the display device 400 calculate the predictive value of power usage after 16 o'clock by using, for example, the record of the same time of the previous day or the same date last year. In this case, the processing server 200, the portable terminal 300 and the display device 400 perform the certain correction on the record at the same time of the previous day or last year to calculate the predictive value of power usage of the day. Further, the correction includes comparing, for example, the weather of the previous day or the same date of last year with that of the day (e.g., temperature, amount of sunshine, amount of rainfall and humidity) and adding and multiplying correction values according to weather. In addition, even in the case of the same time, the record of power usage may be changed according to the day of the week. As a result, the predictive value may be calculated using the record of the same day of the week near the same date of last year. At any rate, the processing server 200 calculates the predictive values of the power usage and the power using rate at each of the time interval including current time and the future time interval using the value of power usage of the past.

In an example of FIG. 3C, the predictive values of the power usage and the power using rate are stored per the time interval defined per 1 hour and the processing server 200, the portable terminal 300 and the display device 400 may store the predictive values of the power usage and the power using rate per the time interval defined per, for example, 10 minutes. That is, the processing server 200, the portable terminal 300 and the display device 400 can calculate the predictive values of the power usage and the power using rate per the time interval shorter than the time interval corresponding to each record in the power information published by the distribution server 100.

When the processing server 200 and the portable terminal 300 generate power information using the power information acquired from the distribution server 100, the generated power information is stored in a format corresponding to the display device 400, and the power information is transmitted to the display device 400.

Therefore, even though the format of the power information published by the distribution server 100 is changed and the changed format does not correspond to the display device 400, the display device 400 can acquire the power information from the processing server 200 to process (analyze) the power information by its own device.

As the case when the format of power information published by the distribution server 100 is changed, the following example may be considered. When the power information is published, for example, as a CSV format, rows in which data are stored or item names of rows may be changed. Further, even when the power information is published in an XML format, the information that is published as, for example, a plain text, may be changed to other formats such as binary or EXI compression.

The processing example of the control of the power supply switching and the operation mode switching by the display device 400 will be described below with reference to FIG. 4.

When the power information is stored in the storage module 402, the control module 404 of the display device 400 extracts the information of the power using rate at the current time and performs the control according to the power using rate. That is, when the power using rate is 70% or less, the control module 404 instructs the power supply module 405 to input the driving power from the AC adaptor 406 and permits the charging of the battery 408. Further, the control module 404 instructs each component of the display device 400 to operate in a normal mode.

When the power using rate is 70% to 80% at the current time, the control module 404 inputs the driving power from the AC adaptor 406, permits the charging of the battery 408, and instructs each component of the display device 400 to operate in the power saving mode.

When the power using rate is 80% to 90% at the current time, the control module 404 inputs the driving power both from the AC adaptor 406 and the battery 408 and inhibits the charging of the battery 408. Further, the control module 404 instructs each component of the display device 400 to operate in the power saving mode.

When the power using rate exceeds 90% at the current time, the control module 404 inputs the driving power from the battery 408 and inhibits the charging of the battery 408. Further, the control module 404 instructs each component of the display device 400 to operate in the power saving mode.

The power using rate defined as a changing point of the control in FIG. 4 is only an example. The display device 400 only needs to switch the control whether the predictive value of the power using rate at the current time exceeds at least certain value.

The portable terminal 300 may transmit the control command so as to allow the display device 400 to perform the control shown in FIG. 4 according to the power using rate at the current time. That is, the portable terminal 300 extracts the predictive value of power usage at the current time and generates the control command according to the extracted predictive value so as to be transmitted to the display device 400 when the portable terminal 300 acquired the power information including the predictive value of the power usage from the processing server 200 or calculated the predictive values of the power usage based on the power information acquired from the distribution server 100.

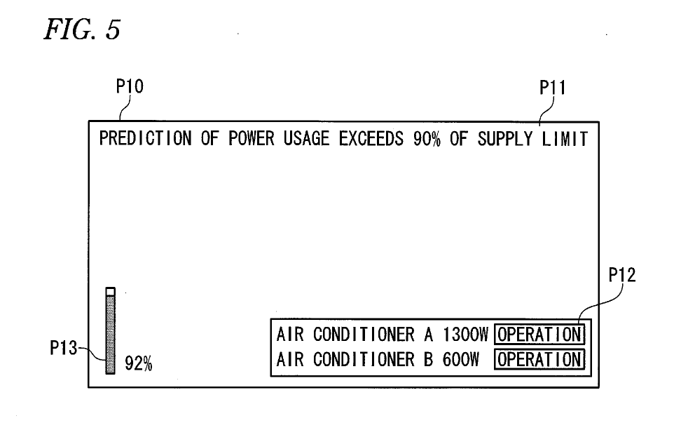

FIG. 5 is an example of the notification screen that is displayed by the display device 400. A screen P10 is an example of a screen being displayed, for example, when the predictive value of the power usage exceeds the certain value at the current time. A notification message P11, a button P12 for controlling external devices, and a gauge P13 representing the predictive value of power usage are displayed on the screen P10. In this case, the button P12 is a button that is operated by the user to control external devices connected to the display device 400 via a network. For example, external device names or power consumption of the external devices are represented around the button. Further, when the input for operating the button is received, the display device 400 displays the screen (not shown) for operating the external devices and transmits the control command according to the user operation for the screen to the external devices.

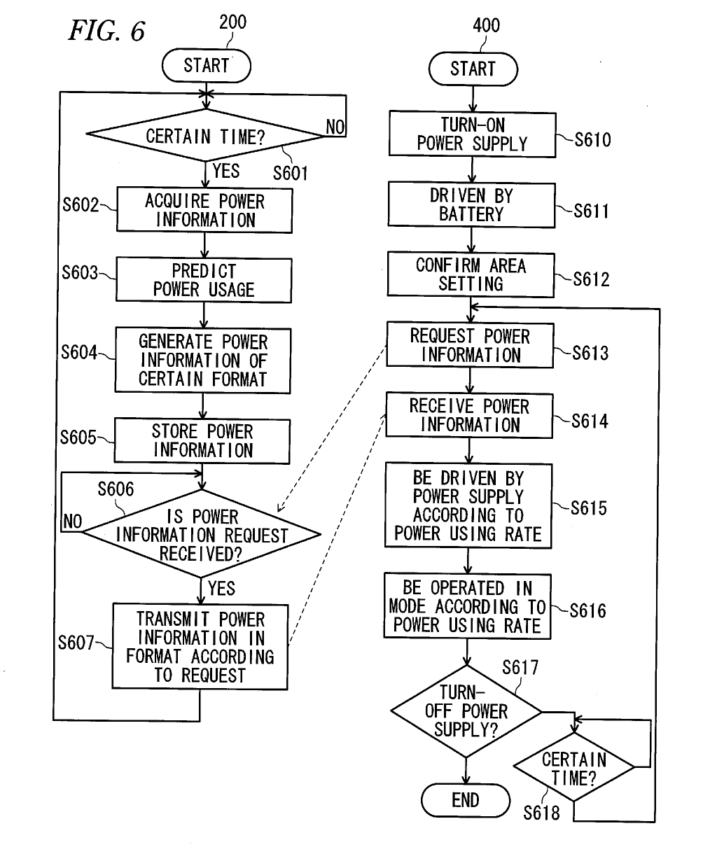

FIG. 6 is a flow chart showing an example of a processing flow in a power control system according to the embodiment. The processing flow is performed by, for example, the distribution server 100, the processing server 200 and the display device 400. Further, an example of a processing flow in which the processing server 200 acquires the power information published by the distribution server 100 will be mainly described in the processing flow.

First, the processing example of the processing server 200 will be described below. When the certain time is reached (Yes of S601), the processing server 200 transmits the power information request to the distribution server 100 to acquire the power information (S602). Further, the processing server 200 calculates the predictive values of the power usage and the power using rate for the current time and the future time based on the acquired record of power usage of the past time and the power supply amount (S603). Continuously, the processing server 200 generates the power information including the information of the calculated predictive value in a certain format (S604). In addition, the processing server 200 may previously acquire the information regarding the format of the power information corresponding to, for example, the display device 400 and may generate the power information in the format. Alternatively, when the corresponding format to the display device 400 is not known, the processing server 200 may also generate a plurality of power information each has the same data contents but having different formats.

The processing server 200 stores the generated power information (S605). Next, when the processing server 200 receives the power information request from the display device 400 (S606), the processing server 200 transmits the power information stored in the own device to the display device 400 (S607). At S606, the processing server 200 may receive the power information request including the information of the identifier of the display device 400 or the information of the format corresponding to the display device 400. The processing server 200 may transmit the power information in the format according to the information included in the power request at step S607.

Next, the processing example of the display device 400 will be described below. When the display device 400 is turned-on (S610), the control module 404 instructs to the power supply module 405 to input the driving power from the battery 408 and the display device 400 drives the battery (S611). Further, the display device 400 confirms the area that is set in its own device (S612). In addition, the display device 400 refers to and confirms the area information set in its own device, for example, in the receiving setting of television broadcasting. In this case, the display device 400 performs the remaining steps of the processing flow if the area that is set in its own device falls within a certain area and otherwise the remaining steps may also be omitted.

Continuously, the display device 400 transmits the power information request to the processing server 200 (S613). In this case, the display device 400 may transmit the power information request including the information for the identifier of its own device or the information of the format corresponding to its own device. Further, when receiving the power information (S614), the display device 400 extracts the information of the power using rate corresponding to the current time stored in the power information. The control module 404 instructs the power supply module 405 to be driven by a power supply according to the power using rate, such that the display device 400 is driven by the power supply according to the power using rate, for example, as shown in FIG. 4 (S615). Further, the control module 404 instructs each component of the display device 400 to be operated in the operation mode according to the power using rate (S616).

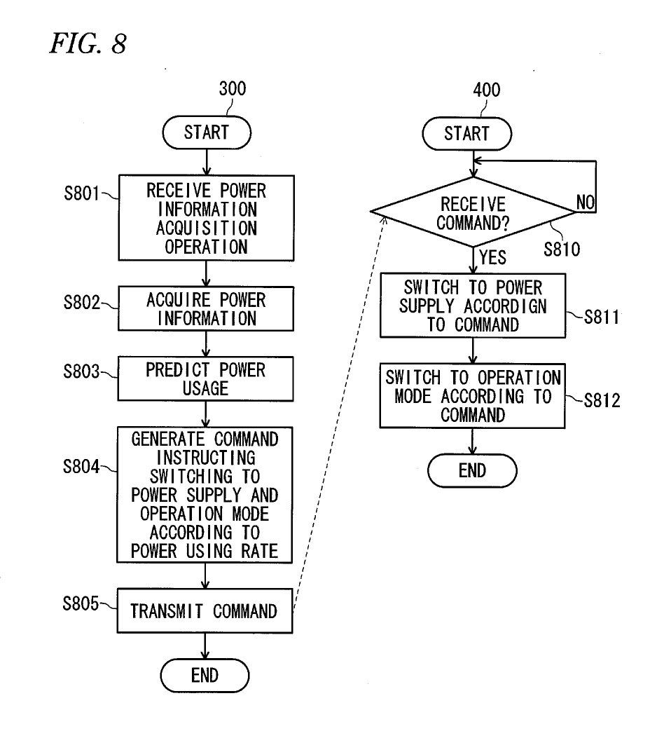

Even though the processing server 200 transmits the power information to the display device 400 in the description of the flow of FIG. 6, the processing server 200 may generate the control command as in the portable terminal 300 in FIG. 8 as described later, and transmit the generated control command to the display device 400. In this case, the processing server 200 generates the control command at S604 of FIG. 6 and transmits the command in response to the power information request at S607. The processing server 200 may receive the request of the control command from the display device 400 at step S606 and respond and transmit the control command for the request at step S607. The display device 400 transmits the request of the control command rather than the power request at step S613 to the processing server 200, and may control the power supply switching and the operation mode switching of its own device according to the received control command at step S613.

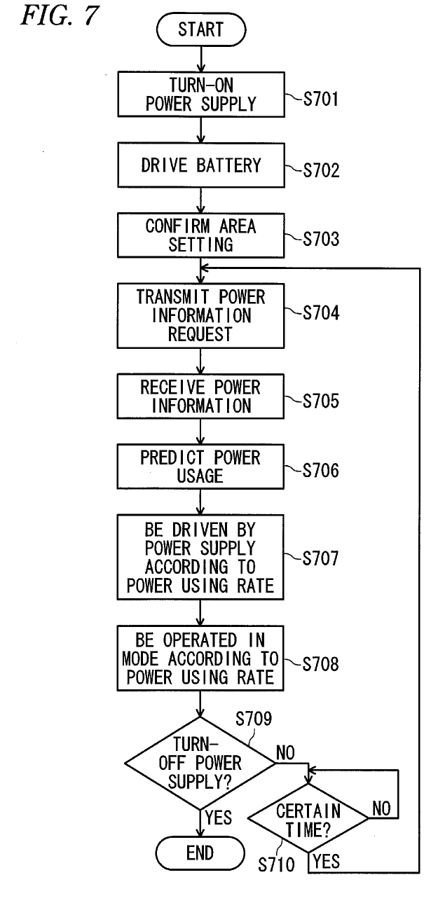

FIG. 7 is a flow chart showing an example of a processing flow in a power control system according to the embodiment. Herein, an example of a processing flow in which the display device 400 acquires the power information published by the distribution server 100 will be mainly described.

When the display device 400 is turned-on (S701), the control module 404 instructs the power supply module 405 to input the driving power from the battery 408 and the display device 400 is driven by the battery (S702). Further, the display device 400 confirms the area that is set in its own device (S703). In addition, the display device 400 refers to and confirms the area information that is set in its own device, for example, in the receiving setting of television broadcasting (S703). In this case, the display device 400 performs the remaining steps of the processing flow if the area that is set in its own device is a certain area and otherwise, the remaining steps of the processing flow may also be omitted.

Continuously, the display device 400 transmits the power information request to the processing server 100 (S704). Further, when the display device 400 receives the power information from the distribution server 100 (S705), the display device 400 calculates the predictive values of the power usage and the power using rate of the current time and the future time based on the record of power usage of the past and the power supply amount included in the acquired power information (S706). In addition, the display device 400 is driven by the power supply according to the calculated power using rate (S707) and is operated in an operation mode according to the power using rate (S708).

When the certain time is reached (Yes of S710) while the power supply is not turned-off (No of S709), the display device 400 returns to the processing of S704 and transmits the power information request and repeats the processing of S704 to S710. Further, at S709, when the power supply is turned-off (Yes of S709), the processing flow is completed.

When the power information cannot be acquired from the distribution server 100, the display device 400 in the processing flow may acquire the power information from the processing server 200. Further, even though the display device 400 can acquire the power information from the distribution server 100, when the format of the power information does not correspond to its own device, the display device 400 may also acquire the power information from the processing server 200. In these cases, the display device 400 may omit the processing of S705.

FIG. 8 is a flow chart showing an example of a processing flow in a power control system according to the embodiment. The processing flow is performed by, for example, the distribution server 100, the portable terminal 300 and the display device 400. An example of a processing flow in which the portable terminal 300 acquires the power information published by the distribution server 100 will be mainly described in the processing flow.

First, the processing example of the portable terminal 300 will be described below. First, when the operation reception module 301 is inputted with a certain operation by the user (S801), the portable terminal 300 transmits the power information request to the distribution server 100 and acquires the power information (S802). Further, the portable terminal 300 calculates the predictive values of the power usage and the power using rate for the current time and the future time based on the acquired record of power usage of the past time and the power supply amount included in the acquired power information (S803).

The portable terminal 300 generates the control command for controlling the display device 400 according to the predictive values of the power using rate at the current time (S804). The control command generated by the portable terminal 300 is to allow the display device 400 to perform, for example, the control shown in FIG. 4 on the predictive value of the power using rate at the current time. Further, the portable terminal 300 transmits the generated command to the display device 400 via home network 600 (S805). In addition, when the portable terminal 300 and the display device 400 correspond to one-to-one communication such as infrared communication, the portable terminal 300 may also transmit the control command via the one-to-one communication.

Continuously, the processing example of the display device 400 will be described. When the command from the portable terminal 300 is received (S810), the display device 400 is driven by the power supply according to the command (S811) and operated in the operation mode according to the command (S812).

In the processing flow, the portable terminal 300 may also acquire the power information from the processing server 200. In this case, the portable terminal may omit the processing of S803.

While certain embodiments have been described, these embodiments have been presented by way of example only, and are not intended to limit the scope of the invention. Indeed, the novel device and method described herein may be embodied in a variety of other forms; furthermore, various omissions, substitutions and changes in the form of the device and method, described herein may be made without departing from the spirit of the invention. The accompanying claims and their equivalents are intended to cover such forms or modifications as would fall within the scope and spirit of the invention

What is claimed is:

1. A power control method comprising:
receiving supply amount information regarding a supply limit of commercial power and consumption information regarding consumption of the commercial power at a past time;
generating predictive information regarding a value of consumption of commercial power at a time after the past time based on the consumption information; and
driving an electronic device by switching between a commercial power supply and a battery power supply according to the supply amount information and the predictive information.

2. The method of claim 1 further comprising:
receiving, by a first device, the supply amount information and the consumption information from a second device connected to the first device through a network;
generating, by the first device, the predictive information based on the received consumption information;
transmitting, by the first device, first information according to the received supply amount information and the generated predictive information to the electronic device;
receiving, by an electronic device, the information transmitted from the first device; and
driving, by the electronic device, a driven device by using a power supply according to the received first information.

3. The method of claim 2, further comprising:
storing, by the first device, format information regarding a format corresponding to the electronic device;
generating, by the first device, the first information in the stored format; and
transmitting, by the first device, the generated first information to the electronic device.

4. The method of claim 3, further comprising:
transmitting, by the first device, the first information instructing the control of the driving power supply according to the received supply amount information and the generated predictive information to the electronic device; and
driving, by the electronic device, the driven device by using the power supply according to the instruction included in the first information transmitted from the first device.

5. The method of claim 3, further comprising:
generating, by the first device, the first information including the received supply amount information and the generated predictive information; and
driving, by the electronic device, the driven device by using the power supply according to the supply amount information and the predictive information included in the first information transmitted from the first device.

6. The method of claim 2, further comprising:
receiving, by the electronic device, the supply amount information and the consumption information from the second device;
notifying, by the electronic device, the first device when the format of the supply amount information and the consumption information are not received from the second device; and
transmitting, by the first device, the first information when receiving the notification.

7. The method of claim 1, further comprising:
receiving the consumption information regarding the consumption per a certain time of the commercial power at the past time; and
generating the predictive information regarding the predictive value per a time interval shorter than the certain time based on the received consumption information.

8. The method of claim 2, further comprising:
receiving, by the first device, an input for operation from a user;
receiving, by the first device, the supply amount information and the consumption information from the second device when receiving the operation input;
generating, by the first device, the predictive information based on the received consumption information; and
transmitting, by the first device, the first information according to the received supply amount information and the generated predictive information to the electronic device.

9. The method of claim 2, further comprising:
displaying, by the electronic device, a notification screen regarding the consumption of the current commercial power according to the received first information.

10. An electronic device, comprising:
an input module configured to receive power from a battery power supply and a commercial power supply;
a receiving module configured to receive supply amount information regarding a supply limit of commercial power and consumption information regarding consumption of the commercial power at a past time from a server connected through a network;
a generation module configured to generate predictive information regarding a predictive value of the consumption of the commercial power at a time after the past time based on the received consumption information; and
a power controller configured to switch between power of the commercial power supply and power of the battery power supply input to the input module according to a ratio of a value represented by the generated predictive information to a value represented by the received supply amount information, and configured to use the power as a driving power of a device.

11. An electronic device, comprising:
a receiving module configured to receive supply amount information regarding a supply limit of commercial power and consumption information regarding consumption of commercial power at a past time from a device connected through a network;
a generation module configured to generate predictive information regarding a predictive value of consumption at a time after the past time based on the received consumption information; and
a transmitter configured to transmit an instruction command instructing an external electronic device to perform an operation according to the received supply amount information and the generated predictive information to the external electronic device.
